(19) United States
(12) Patent Application Publication
(10) Pub. No.: US 2026/0220269 A1
(43) Pub. Date: Jul. 30, 2026

(54) TECHNIQUES FOR A MEMORY MODULE PER ROW ACTIVATE COUNTER

(71) Applicant: Intel Corporation, Santa Clara, CA (US)

(72) Inventors: George Vergis, Portland, OR (US); Shigeki Tomishima, Portland, OR (US)

(73) Assignee: Intel Corporation, Santa Clara, CA (US)

(21) Appl. No.: 19/573,108

(22) Filed: Mar. 20, 2026

Related U.S. Application Data
(63) Continuation of application No. 18/401,428, filed on Dec. 30, 2023.

(51) Int. Cl. G06F 21/56; G06F 21/55

(52) U.S. Cl. CPC G06F 21/566; G06F 21/554; G06F 2221/034

(57) ABSTRACT

Examples include techniques for a memory module per row activate counter. The techniques include detecting a row hammer or row disturb condition for a row address at a volatile memory device if an activate count to the row address matches a threshold count. The activate count is maintained by a controller for the memory module. Detection of the row hammer or row disturb condition can cause refresh management actions to mitigate the row hammer or row disturb condition.

### CLAIM TO PRIORITY

This Application is a continuation of and claims the benefit of and priority to U.S. Application No. Ser. No. 18/401,428, entitled TECHNIQUES FOR A MEMORY MODULE PER ROW ACTIVATE COUNTER, by George Vergis, et al., filed Dec. 30, 2023, the entire contents of which are incorporated herein by reference.

### TECHNICAL FIELD

Descriptions are generally related to techniques for detecting and mitigating row hammer or row disturb attacks to a memory device.

### BACKGROUND

Volatile memory devices, such as DRAM (dynamic random access memory) devices, have a known attack vector referred to as row hammer or row disturb. A row hammer or row disturb condition refers to the flipping of at least one bit of an adjacent row (the victim row) by repeated access to a target row (aggressor row) within a time period. The repeated access to the target row causes a change in the value of a victim row that is adjacent or proximate to the target/aggressor row. Repeated activation of the target row causes migration of charge across the passgate of the victim row. With repeated manipulation of a target row with a known pattern, an attacker can intentionally flip one or more bits of one or more victim rows. Multiple DRAM devices or DRAM chips can be arranged to operate on a memory module such as dual in-line memory module (DIMM).

### BRIEF DESCRIPTION OF THE DRAWINGS

FIG. 1 illustrates an example first system.

FIG. 2 illustrates example dual in-line memory module.

FIG. 3 illustrates an example process flow.

FIG. 4 illustrates an example second system.

FIG. 5 illustrates an example third system.

FIG. 6 illustrates an example fourth system.

### DETAILED DESCRIPTION

A recently developed technique to detect and/or mitigate row hammer or row disturb attacks to a DRAM device can be referred to as perfect row hammer tracking (PRHT) or per row activate counting (PRAC). PRHT or PRAC can require internal circuitry of a DRAM device to increment an internal counter whose bits are stored in memory cells included in a row. The storing of the internal activate count ensures that the internal circuitry of the DRAM device knows how many times each row has been activated. Thus, the DRAM device can internally monitor for a row hammer condition and perform or initiate actions for a correction prior to/when a row reaching/reached a threshold number of activates.

Implementing PRHT or PRAC can require a significant amount of circuitry overhead to support the logic needed to track row activations. Also, increased row cycle times associated with PRHT or PRAC can reduce DRAM device access performance. The increased row cycle time is needed to accommodate a read-modify-write of each activated row of a DRAM access. Increasing a number of banks of a DRAM device to allow more parallel access to the DRAM device memory cells can partially offset performance impacts of implementing PRHT or PRAC. However, increasing the banks adds cost to the DRAM device and increases complexity to the controller scheduling, and may not be completely effective at offsetting the performance impact.

A solution to address access performance hits for accommodating read-modify-write of each activated row includes a memory controller instructing a DRAM device to not increment the count of each access for a number greater than one. In other words, the memory controller instructs the internal circuitry to not increment the count for subsequent accesses up to the number indicated. This solution can minimize performance hits by reducing a number of read-modify-writes. However, a significant amount of circuitry overhead is still needed at the DRAM device to track an activate count, to receive commands from the memory controller on how to increment the activate count and to take corrective action if a row hammer or row disturb attack is detected. Also, although access performance hits are reduced, access performance can still be impacted, and controller scheduling is still somewhat complex. In deployment scenarios, such as, but not limited to, a data center deployment, a dual in-line memory module (DIMMs) can separately include a large number of DRAM devices. The added circuitry overhead, performance impacts and complexity issues can cause PRHT or PRAC techniques implemented at internal DRAM circuitry to be a prohibitively costly solution to detect and mitigate row hammer or row disturb attacks in this type of data center deployment.

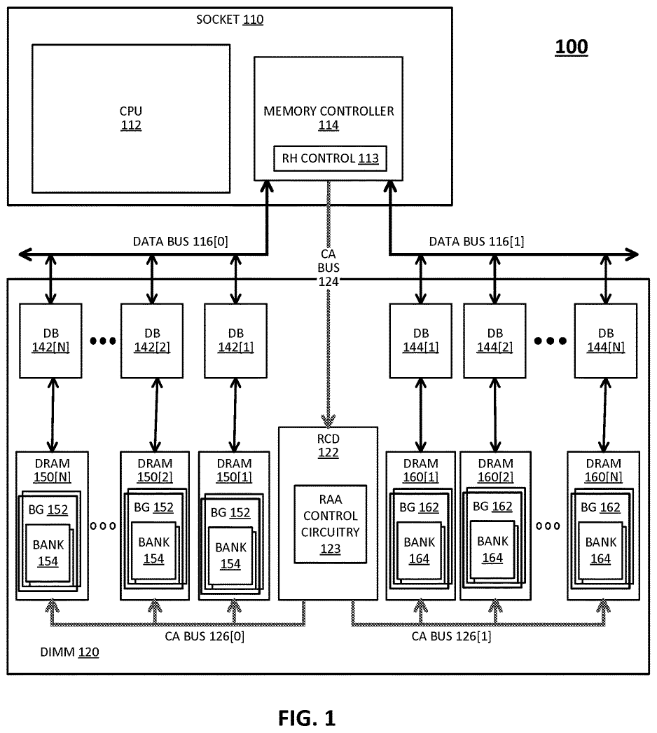

FIG. 1 is a block diagram of an example of a system with a memory module. System 100 includes socket 110 coupled to DIMM 120. Socket 110 represents a CPU socket, which can include CPU 112 and memory controller 114. DIMM 120 includes multiple DRAM devices.

System 100 illustrates an example of a system with memory devices that share a control bus or command bus (command/address (C/A) bus 126[0] for one channel and C/A bus 126[1] for the other channel) and data buses (data bus 116[0] for the one channel and data bus 116[1] for the other channel). The memory devices are represented as DRAM (dynamic random access memory) devices. Each channel has N DRAM devices, DRAM 150[1:N] (collectively, DRAM devices 150) for one channel, and DRAM 160[1:N] (collectively, DRAM devices 160) for the other channel, where N can be any integer. In some examples, N includes one or more (error checking and correction (ECC) DRAM devices in addition to the data devices. Each DRAM device 150 and each DRAM device 160 can represent a memory chip with a command bus interface to memory controller 114, where the command bus interface can be routed through RCD 122.

In one example, the two separate channels share C/A bus 124 connection between memory controller 114 and RCD 122. In one example, the separate channels can have separate C/A buses (not shown in FIG. 1). The DRAM devices can be individually accessed with device specific commands and can be accessed in parallel with parallel commands.

Registering clock driver (RCD) 122 (which can also be referred to as a registered clock driver) represents a controller for DIMM 120. In one example, RCD 122 can receive information from memory controller 114 and can buffer the signals to the various DRAM devices included on DIMM 120. By buffering the input command signals from memory controller 114, the controller sees the load of RCD 122 on the command/address (CA bus 124), which can then control the timing and signaling to the DRAM devices.

In one example, RCD 122 controls the command signals to DRAM devices 150 through CA bus 126[0] and controls the signals to DRAM devices 160 through CA bus 126[1]. In one example, RCD 122 has independent command ports for separate channels. In one example, DIMM 120 includes data buffers to buffer the data bus signals between the DRAM devices of DIMM 120 and memory controller 114.

Data bus 116[0] provides a data bus for DRAM devices 150, which are buffered with data buffer (DB) 142[1:N] (collectively, DBs 142). Data bus 116[1] provides a data bus for DRAM devices 160, which are buffered with DB 144[1:N] (collectively, DBs 144). System 100 illustrates a one-to-one relationship between data buffers and DRAM devices. In one example, there are fewer data buffers than DRAM devices, with DRAM devices sharing a data buffer.

CA bus 126[0] and CA bus 126[1] (collectively, CA buses 126) are typically unilateral buses or unidirectional buses to carry command and address information from memory controller 114 to the DRAM devices. Thus, CA buses 126 can be multi-drop buses. Data bus 116[0] and data bus 116[1], collectively data buses 116, are traditionally bidirectional, point-to-point buses.

In one example, each DRAM 150 includes a memory array organized as multiple banks 154 and each DRAM 160 includes a memory array organized as multiple banks 164. The banks at DRAM 150 and DRAM 160 can be grouped in bank groups (BG) 152 or 162, respectively. The memory array can be accessed by row address, bank address, and bank group address, with different combinations of addresses selecting different groups of bits for access.

According to some examples, as described in more detail below, RCD 122 includes a rolling accumulated ACT (RAA) control circuitry 123 that can be configured to intercept or sniff all commands sent via CA bus 124 to DRAM 150 or DRAM 160 and look for activate (ACT) commands that include a row activation with row address. If an intercepted or sniffed command is an ACT command, RAA control circuitry 123 can include logic and/or features to capture a row address to be activated by the command and increment a row address activate count. When a row activate counter for any row of DRAM 150 or DRAM 160 reaches a threshold, then the logic and/or circuitry of RAA control circuitry 123 can alert memory controller 114 of a possible row hammer or row disturb attack that can cause memory controller 114 to issue a refresh (REF) or refresh management (RFM) command to possibly affected adjacent rows or to independently take mitigation actions in addition to alerting the memory controller 114.

In one example, memory controller 114 includes row hammer (RH) control 113. RH control 113 enables memory controller 114 to respond to row hammer or row disturb conditions detected by RAA control circuitry 123 or detected by other means. In one example, RH control 113 enables memory controller 114 to generate a directed refresh management (DRFM) command to cause affected adjacent rows to be refreshed responsive to an alert received from RAA control circuitry 123. In other examples, RAA control circuitry 123 can generate or issue the DRFM command upon detected row hammer or row disturb conditions and send an alert to memory controller 114 to indicate that mitigation actions have been taken.

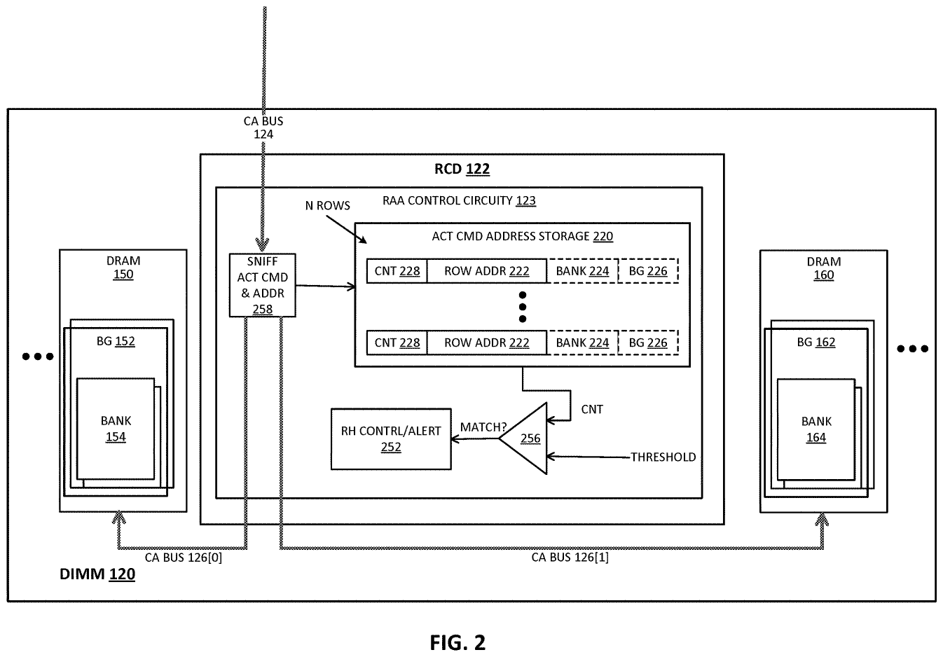

FIG. 2 illustrates a more detailed example of portions of DIMM 120. In some examples, as shown in FIG. 2, logic and/or features included in RAA control circuitry 123 can include an ACT command (CMD) address storage 220, an RH control/alert 252, a comparator 256, and a sniff ACT CMD & address (ADDR) 258.

According to some examples, ACT CMD address storage 220 can be a memory structure such as a look up table maintained in a memory at RCD 122 and/or in a memory accessible to RAA control circuitry 123 (e.g., in a dedicated DRAM). For these examples, ACT CMD address storage 220 can be arranged to store row addresses that have been accessed for each bank of DRAM 150 or DRAM 160. Row address (ADDR) 222 can represent row addresses maintained in ACT CMD address storage 220. In one example, each ACT CMD address storage 220 includes an address count (CNT) 228. CNT 228 can indicate how many times an ACT command has been sent/addressed to a given row. In some examples, to reduce memory capacity needed to maintain activate counts of all rows a DRAM device, CNT 228 can represent an activate count for rows of an entire rank of DRAM devices.

In one example, responsive to sniff ACT CMD & ADDR 258 detecting an ACT command has been sent/addressed to a given row address, CNT 228 is incremented for that given row in ACT CMD address storage 220. CNT 228 for the given row address is then provided to comparator 256 to determine whether the updated CNT 228 meets or exceeds a threshold count. The threshold count, for example, can indicate that a row hammer or row disturb condition has been detected. In some examples, the threshold count can be referred to as a rolling accumulated ACT maximum management threshold (RAAMMT). If RAAMMT has been met or exceeded, RH control/alert 252 can either alert a memory controller that a row hammer or row disturb condition has been detected at the given row and/or take refresh management actions such as generating or issuing a DRFM command to cause adjacent row(s) to the given row to be refreshed. Following the refresh management actions by the memory controller or by RH control/alert 252, CNT 228 for the given row address can be reset to 0. A primary capability of the DRFM command can be to establish row adjacency surrounding the given row (e.g., address[n−1], address[n+1]. Responsive to the DRFM command, the given row and adjacent rows of DRAM device are refreshed together to mitigate the effects of a row hammer or row disturb attack. Typically, DRAM refresh counter (address of the row that is being refreshed) is internally generated, the refresh command cannot be directed to a target row. However, RH control from either the memory controller or RAA control circuitry 123 can require the DRAM device to accept the DFRM command preceded by an external/adjacent row address for refreshing. Thus, by-passing the row addressed by an refresh counter that is internal to the DRAM device.

In some examples, RAA control circuitry 123 can be an application specific integrated circuitry (ASIC), field programmable gate array (FPGA) or integrated portion of a processor or a processor circuit. Also, controller circuitry of RCD 122 (not shown) can be part of a same ASIC, FPGA or integrated portion of the processor or the processor circuit that also includes RAA control circuitry 123. Alternatively, RAA control circuitry and controller circuitry of RCD 122 can be separate ASICs or FPGAs.

Included herein is an example process flow related to system 100 that can be representative of example methodologies for performing novel aspects for detecting and/or mitigating row hammer or row disturb attacks to a memory device such as a DRAM device. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A process flow can be implemented in software, firmware, and/or hardware. In software and firmware embodiments, a process flow can be implemented by computer executable instructions stored on at least one non-transitory computer readable medium or machine readable medium, such as an optical, magnetic or semiconductor storage. The embodiments are not limited in this context.

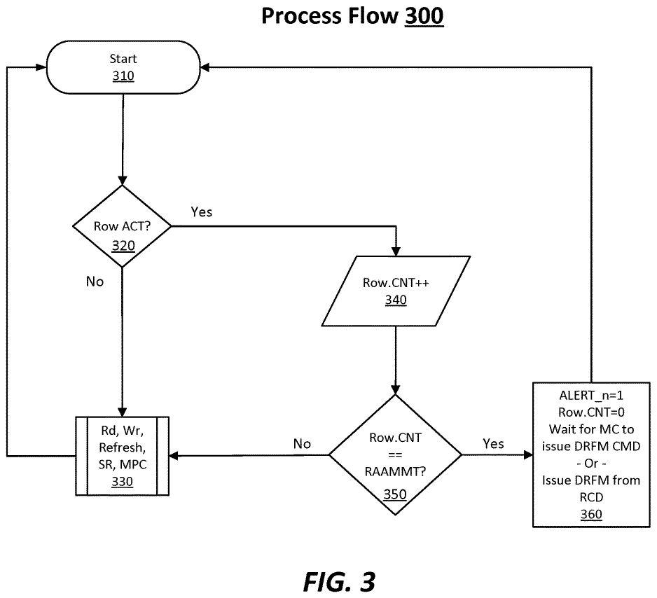

FIG. 3 illustrates an example process flow 300. According to some examples, process flow 300 can be implemented to detect and mitigate row hammer or row disturb attacks to a DRAM device located on a DIMMs having an RCD that intercepts or sniffs a CA bus for commands sent from a memory controller. For example, DIMM 120 as shown in FIGS. 1-2 includes RCD 122 coupled with CA bus 124. Also, circuitry of RCD 122 such as RAA control circuitry 123 can include logic and/or features to facilitate detection and mitigation of row hammer or row disturb attacks such as, but not limited to, ACT CMD address storage 220, RH control/alert 252, comparator 256, and sniff ACT CMD & ADDR 258.

In some examples, at 310, process flow is started when logic and/or features of RAA control circuitry 123 such as sniff ACT CMD & ADDR 258 intercepts or sniffs a command sent via CA bus 124 that is addressed to DRAM 150 or DRAM 160.

According to some examples, at 320, sniff ACT CMD & ADDR 258 can be configured to determine whether the command sent via CA bus 124 causes a row activation. For example, if the command is an ACT command targeted to a row maintained in DRAM 150 or DRAM 160, a row activation is determined, and process flow 300 moves to block 340. If the command is a refresh command or a multipurpose command (MPC), no row activation is determined, and process flow 300 moves to block 330.

In some examples, moving from decision block 320 to block 330, the command is forwarded to the targeted DRAM for execution. For example, to execute a refresh operation, a read (Rd) operation, a write (Wr) operation, or to respond to an MPC. Process flow 300 can then return back to 310.

According to some examples, moving from decision block 320 to block 340, a row count (CNT) for the row addressed in the ACT command is incremented by RAA control circuitry 123 and the updated CNT is maintained in ACT CMD address storage 220 for the row addressed in the command.

In some examples, at 350, logic and/or features of RAA control circuitry 123 such as comparator 256 can compare the updated CNT for the row addressed in the ACT command to a threshold count. For these examples, the threshold count can be a rolling accumulated ACT maximum management threshold (RAAMMT). If the updated CNT matches RAAMMT, then process flow 300 moves to block 360. If the updated CNT does not match RAAMMT, then process flow 300 moves to block 330 and the ACT command is forwarded to DRAM 150 or DRAM 160 for execution.

According to some examples, moving from decision block 350 to block 360, logic and/or features of RAA control circuitry 123 such as RH control/alert 252 can cause an ALERT_n=1 to be sent to the memory controller to indicate that a row hammer or row disturb condition has been detected for the row addressed in the command. The memory controller can then initiate a refresh management operations to cause adjacent rows to be refreshed (e.g., issue a DRFM command). Also, the ACT command can be blocked or not be forwarded to the target DRAM to prevent any further attempts to flip bits in adjacent rows. The CNT for the row addressed in the command can then be reset to 0. Alternatively, RH control/alert 252 can be configured to directly issue a DRFM command to the target DRAM to cause adjacent rows to be refreshed and then reset CNT to 0. For this alternative example, RH control/alert 252 can also generate an ALERT_n=1 and send the message to the memory controller to indicate that a row hammer or row disturb condition has been detected and mitigated. The memory controller can then take additional actions (e.g., block subsequent ACT commands from a possible source of the row hammer attack such as a rogue application). Also, in some examples, RH control/alert 252 can cause some back pressure to be placed on the memory controller to provide some additional time for the DRFM command to be executed. For example, parity bits can be “poisoned” for a brief period of time to cause the memory controller to resend ACT commands to rows being refreshed due to a parity error. For these examples, causing the resending of ACT commands could buy enough time to complete execution of the DRFM command. Process flow 300 can then return back to 310.

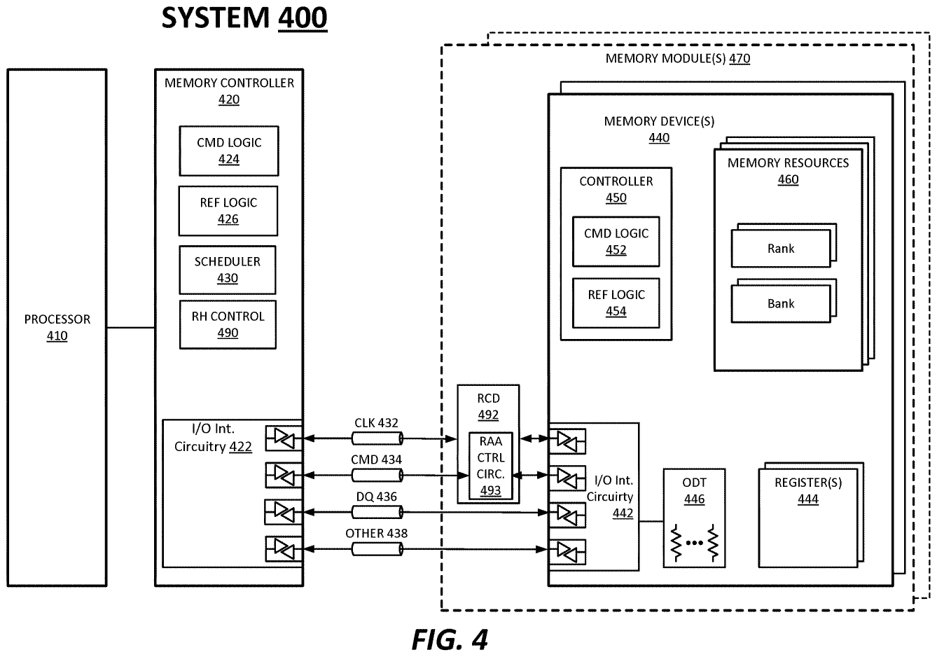

FIG. 4 illustrates an example of a memory subsystem in which row hammer or row disturb conditions can be detected and/or mitigated at a memory module. System 400 includes a processor and elements of a memory subsystem in a computing device. System 400 represents a system in accordance with an example of system 100.

In one example, memory module(s) 470 includes an RCD 492 that includes RAA control circuitry 493. RAA control circuitry 493 can include similar logic and/features as mentioned above and shown in FIG. 2 for RAA control circuitry 123 to maintain an activate count for ACT commands addressed to each row address of memory device(s) 440. The activate count can be incremented responsive to an ACT command received from memory controller 420 and based on a comparison of the incremented activate count to a threshold count, a row hammer or a row disturb condition can be detected and/or mitigated as mentioned above and shown in FIG. 3. Also, RAA control circuitry 493 can be configured to generate an alert based on a detected row hammer or row disturb conditions such that a RH control 490 at memory controller 420 can issue commands (e.g., DRFM commands) to mitigate the detected row hammer or row disturb conditions.

Processor 410 represents a processing unit of a computing platform that may execute an operating system (OS) and applications, which can collectively be referred to as the host or the user of the memory. The OS and applications execute operations that result in memory accesses. Processor 410 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 400 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR3 (double data rate version 3), JESD79-3F, originally released by JEDEC in July 2012, DDR4 (DDR version 4), JESD79-4C, originally published in January 2020, DDR5 (DDR version 5), JESD79-5B originally published in September 2022, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published by in June 2021), WIO2 (Wide Input/output version 2), JESD229-2 originally published in August 2014, HBM (High Bandwidth Memory), JESD235B, originally published in December 2018, HBM 2 (HBM version 2), JESD235D, originally published in January 2020, or HBM3 (HBM version 3), JESD238A, originally published in January 2023, or other memory technologies or combinations of memory technologies, as well as technologies based on derivatives or extensions of such above-mentioned specifications. The JEDEC standards or specifications are available at www.jedec.org.

Memory controller 420 represents one or more memory controller circuits or devices for system 400. Memory controller 420 represents control logic that generates memory access commands in response to the execution of operations by processor 410. Memory controller 420 accesses one or more memory devices 440. Memory devices 440 can be DRAM devices in accordance with any referred to above. In one example, memory devices 440 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 420 manages a separate memory channel, although system 400 can be configured to have multiple channels managed by a single controller, or to have multiple controllers on a single channel. In one example, memory controller 420 is part of host processor 410, such as logic implemented on the same die or implemented in the same package space as the processor.

Memory controller 420 includes I/O interface circuitry 422 to couple to a memory bus, such as a memory channel as referred to above. I/O interface circuitry 422 (as well as I/O interface circuitry 442 of memory device 440) can include pins, pads, connectors, signal lines, traces, wires, or other hardware to connect the devices, or a combination of these. I/O interface circuitry 422 can include a hardware interface. As illustrated, I/O interface circuitry 422 includes at least drivers/transceivers for signal lines. Commonly, wires within an integrated circuit interface couple with a pad, pin, or connector to interface signal lines or traces or other wires between devices. I/O interface circuitry 422 can include drivers, receivers, transceivers, or termination, or other circuitry or combinations of circuitry to exchange signals on the signal lines between the devices. The exchange of signals includes at least one of transmit or receive. While shown as coupling I/O interface circuitry 422 from memory controller 420 to I/O interface circuitry 442 of memory device 440, it will be understood that in an implementation of system 400 where groups of memory devices 440 are accessed in parallel, multiple memory devices can include I/O interfaces to the same interface of memory controller 420. In an implementation of system 400 including one or more memory modules 470, I/O interface circuitry 442 can include interface hardware of the memory module in addition to interface hardware on the memory device itself. Other memory controllers 420 will include separate interfaces to other memory devices 440.

The bus between memory controller 420 and memory devices 440 can be implemented as multiple signal lines coupling memory controller 420 to memory devices 440. The bus may typically include at least clock (CLK) 432, command/address (CMD) 434, and write data (DQ) and read data (DQ) 436, and zero or more other signal lines 438. In one example, a bus or connection between memory controller 420 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 400 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 420 and memory devices 440. An example of a serial bus technology is 8B10B encoding and transmission of high-speed data with embedded clock over a single differential pair of signals in each direction. In one example, CMD 434 represents signal lines shared in parallel with multiple memory devices. In one example, multiple memory devices share encoding command signal lines of CMD 434, and each has a separate chip select (CS_n) signal line to select individual memory devices.

It will be understood that in the example of system 400, the bus between memory controller 420 and memory devices 440 includes a subsidiary command bus CMD 434 and a subsidiary bus to carry the write and read data, DQ 436. In one example, the data bus can include bidirectional lines for read data and for write/command data. In another example, the subsidiary bus DQ 436 can include unidirectional write signal lines for write and data from the host to memory, and can include unidirectional lines for read data from the memory to the host. In accordance with the chosen memory technology and system design, other signals 438 may accompany a bus or sub bus, such as strobe lines DQS. Based on design of system 400, or implementation if a design supports multiple implementations, the data bus can have more or less bandwidth per memory device 440. For example, the data bus can support memory devices that have either a x4 interface, a x8 interface, a x16 interface, or other interface. The convention “xW,” where W is an integer that refers to an interface size or width of the interface of memory device 440, which represents a number of signal lines to exchange data with memory controller 420. The interface size of the memory devices is a controlling factor on how many memory devices can be used concurrently per channel in system 400 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 440 and memory controller 420 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 440 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 440 represent memory resources for system 400. In one example, each memory device 440 is a separate memory die. In one example, each memory device 440 can interface with multiple (e.g., 2) channels per device or die. Each memory device 440 includes I/O interface circuitry 442, which has a bandwidth determined by the implementation of the device (e.g., x16 or x8 or some other interface bandwidth). I/O interface circuitry 442 enables the memory devices to interface with memory controller 420. I/O interface circuitry 442 can include a hardware interface, and can be in accordance with I/O interface circuitry 422 of memory controller, but at the memory device end. In one example, multiple memory devices 440 are connected in parallel to the same command and data buses. In another example, multiple memory devices 440 are connected in parallel to the same command bus, and are connected to different data buses. For example, system 400 can be configured with multiple memory devices 440 coupled in parallel, with each memory device responding to a command, and accessing memory resources 460 internal to each. For a Write operation, an individual memory device 440 can write a portion of the overall data word, and for a Read operation, an individual memory device 440 can fetch a portion of the overall data word. The remaining bits of the word will be provided or received by other memory devices in parallel.

In one example, memory devices 440 are disposed directly on a motherboard or host system platform (e.g., a PCB (printed circuit board) on which processor 410 is disposed) of a computing device. In one example, memory devices 440 can be organized into memory modules 470. In one example, memory modules 470 represent dual inline memory modules (DIMMs). In one example, memory modules 470 represent other organization of multiple memory devices to share at least a portion of access or control circuitry, which can be a separate circuit, a separate device, or a separate board from the host system platform. Memory modules 470 can include multiple memory devices 440, and the memory modules can include support for multiple separate channels to the included memory devices disposed on them. In another example, memory devices 440 may be incorporated into the same package as memory controller 420, such as by techniques such as multi-chip-module (MCM), package-on-package, through-silicon via (TSV), or other techniques or combinations. Similarly, in one example, multiple memory devices 440 may be incorporated into memory modules 470, which themselves may be incorporated into the same package as memory controller 420. It will be appreciated that for these and other implementations, memory controller 420 may be part of host processor 410.

Memory devices 440 each include one or more memory arrays 460. Memory array 460 represents addressable memory locations or storage locations for data. Typically, memory array 460 is managed as rows of data, accessed via wordline (rows) and bitline (individual bits within a row) control. Memory array 460 can be organized as separate channels, ranks, and banks of memory. Channels may refer to independent control paths to storage locations within memory devices 440. Ranks may refer to common locations across multiple memory devices (e.g., same row addresses within different devices) in parallel. Banks may refer to sub-arrays of memory locations within a memory device 440. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 440 include one or more registers 444. Register 444 represents one or more storage devices or storage locations that provide configuration or settings for the operation of the memory device. In one example, register 444 can provide a storage location for memory device 440 to store data for access by memory controller 420 as part of a control or management operation. In one example, register 444 includes one or more Mode Registers. In one example, register 444 includes one or more multipurpose registers. The configuration of locations within register 444 can configure memory device 440 to operate in different “modes,” where command information can trigger different operations within memory device 440 based on the mode. Additionally or in the alternative, different modes can also trigger different operation from address information or other signal lines depending on the mode. Settings of register 444 can indicate configuration for I/O settings (e.g., timing, termination or ODT (on-die termination) 446, driver configuration, or other I/O settings).

In one example, memory device 440 includes ODT 446 as part of the interface hardware associated with I/O interface circuitry 442. ODT 446 can be configured as mentioned above, and provide settings for impedance to be applied to the interface to specified signal lines. In one example, ODT 446 is applied to DQ signal lines. In one example, ODT 446 is applied to command signal lines. In one example, ODT 446 is applied to address signal lines. In one example, ODT 446 can be applied to any combination of the preceding. The ODT settings can be changed based on whether a memory device is a selected target of an access operation or a non-target device. ODT 446 settings can affect the timing and reflections of signaling on the terminated lines. Careful control over ODT 446 can enable higher-speed operation with improved matching of applied impedance and loading. ODT 446 can be applied to specific signal lines of I/O interface 442, 422 (for example, ODT for DQ lines or ODT for CA lines), and is not necessarily applied to all signal lines.

Memory device 440 includes controller 450, which represents control logic within the memory device to control internal operations within the memory device. For example, controller 450 decodes commands sent by memory controller 420 and generates internal operations to execute or satisfy the commands. Controller 450 can be referred to as an internal controller, and is separate from memory controller 420 of the host and separate from RAA control circuitry 493 of RCD 492. Controller 450 can determine what mode is selected based on register 444, and configure the internal execution of operations for access to memory resources 460 or other operations based on the selected mode. Controller 450 generates control signals to control the routing of bits within memory device 440 to provide a proper interface for the selected mode and direct a command to the proper memory locations or addresses. Controller 450 includes command logic 452, which can decode command encoding received on command and address signal lines. Thus, command logic 452 can be or include a command decoder. With command logic 452, memory device can identify commands and generate internal operations to execute requested commands.

Referring again to memory controller 420, memory controller 420 includes command (CMD) logic 424, which represents logic or circuitry to generate commands to send to memory devices 440. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 440, memory controller 420 can issue commands via I/O interface circuitry 422 that can be routed through RCD 492 to cause memory device 440 to execute the commands. In one example, controller 450 of memory device 440 receives and decodes command and address information received via I/O interface circuitry 442 that are routed through RCD 492 and originating from memory controller 420. Based on the received command and address information, controller 450 can control the timing of operations of the logic and circuitry within memory device 440 to execute the commands. Controller 450 is responsible for compliance with standards or specifications within memory device 440, such as timing and signaling requirements. Memory controller 420 can implement compliance with standards or specifications by access scheduling and control.

Memory controller 420 includes scheduler 430, which represents logic or circuitry to generate and order transactions to send to memory device 440. From one perspective, the primary function of memory controller 420 could be said to schedule memory access and other transactions to memory device 440. Such scheduling can include generating the transactions themselves to implement the requests for data by processor 410 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 420 typically includes logic such as scheduler 430 to allow selection and ordering of transactions to improve performance of system 400. Thus, memory controller 420 can select which of the outstanding transactions should be sent to memory device 440 in which order, which is typically achieved with logic much more complex that a simple first-in first-out algorithm. Memory controller 420 manages the transmission of the transactions to memory device 440, and manages the timing associated with the transaction. In one example, transactions have deterministic timing, which can be managed by memory controller 420 and used in determining how to schedule the transactions with scheduler 430.

In one example, memory controller 420 includes refresh (REF) logic 426. Refresh logic 426 can be used for memory resources that are volatile and need to be refreshed to retain a deterministic state. In one example, refresh logic 426 indicates a location for refresh, and a type of refresh to perform. Refresh logic 426 can trigger self-refresh within memory device 440, or execute external refreshes which can be referred to as auto refresh commands) by sending refresh commands, or a combination. In one example, controller 450 within memory device 440 includes refresh logic 454 to apply refresh within memory device 440. In one example, refresh logic 454 generates internal operations to perform refresh in accordance with an external refresh received from memory controller 420. Refresh logic 454 can determine if a refresh is directed to memory device 440, and what memory resources 460 to refresh in response to the command. An external refresh can include, but is not limited to a directed refresh management (DRFM) command that can be sent by RH control 490 of memory controller 420 or RAA control circuitry 493 of RCD 492.

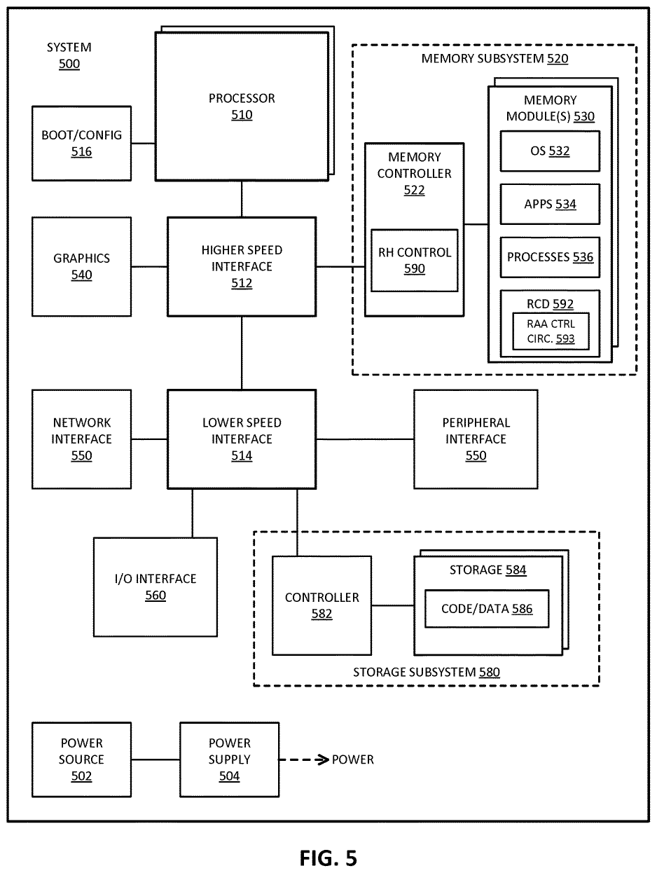

FIG. 5 illustrates an example of a computing system in which row hammer or row disturb conditions can be detected and/or mitigated at a memory module of a memory subsystem. System 1100 represents a computing device in accordance with any example herein, and can be a laptop computer, a desktop computer, a tablet computer, a server, a gaming or entertainment control system, embedded computing device, or other electronic device. System 500 can represent a system with storage or a memory subsystem in accordance with an example of system 100.

In one example, system 500 includes memory subsystem 520 that has an RCD 592 in a memory module(s) 530. RCD 592 can include RAA control circuitry 593. RAA control circuitry 593 can include similar logic and/features as mentioned above and shown in FIG. 2 for RAA control circuitry 123 to maintain an activate count for ACT commands addressed to each row address of volatile memory devices resident on memory module(s) 530. The activate count can be incremented responsive to an ACT command received from memory controller 522 and based on a comparison of the incremented activate count to a count threshold, a row hammer or a row disturb condition can be detected and/or mitigated as mentioned above and shown in FIG. 3. Also, RAA control circuitry 593 can be configured to generate an alert based on a detected row hammer or row disturb conditions such that a RH control 590 at memory controller 520 can issue commands (e.g., DRFM commands) to mitigate the detected row hammer or row disturb conditions.

System 500 includes processor 510 can include any type of microprocessor, central processing unit (CPU), graphics processing unit (GPU), processing core, or other processing hardware, or a combination, to provide processing or execution of instructions for system 500. Processor 510 can be a host processor device. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or a combination of such devices.

System 500 includes boot/config 516, which represents storage to store boot code (e.g., basic input/output system (BIOS)), configuration settings, security hardware (e.g., trusted platform module (TPM)), or other system level hardware that operates outside of a host OS. Boot/config 516 can include a nonvolatile storage device, such as read-only memory (ROM), flash memory, or other memory devices.

In one example, system 500 includes interface 512 coupled to processor 510, which can represent a higher speed interface or a high throughput interface for system components that need higher bandwidth connections, such as memory subsystem 520 or graphics interface components 540. Interface 512 represents an interface circuit, which can be a standalone component or integrated onto a processor die. Interface 512 can be integrated as a circuit onto the processor die or integrated as a component on a system on a chip. Where present, graphics interface 540 interfaces to graphics components for providing a visual display to a user of system 500. Graphics interface 540 can be a standalone component or integrated onto the processor die or system on a chip. In one example, graphics interface 540 can drive a high definition (HD) display or ultra high definition (UHD) display that provides an output to a user. In one example, the display can include a touchscreen display. In one example, graphics interface 540 generates a display based on data stored in memory module(s) 530 or based on operations executed by processor 510 or both.

Memory subsystem 520 represents the main memory of system 500, and provides storage for code to be executed by processor 510, or data values to be used in executing a routine. Memory subsystem 520 can include one or more varieties of random-access memory (RAM) such as DRAM, 3DXP (three-dimensional crosspoint), or other memory devices, or a combination of such devices. Memory module(s) 530 stores and hosts, among other things, operating system (OS) 532 to provide a software platform for execution of instructions in system 500. Additionally, applications 534 can execute on the software platform of OS 532 from memory module(s) 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory module(s) 530. It will be understood that memory controller 522 could be a physical part of processor 510 or a physical part of interface 512. For example, memory controller 522 can be an integrated memory controller, integrated onto a circuit with processor 510, such as integrated onto the processor die or a system on a chip.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 500 includes interface 514, which can be coupled to interface 512. Interface 514 can be a lower speed interface than interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can exchange data with a remote device, which can include sending data stored in memory or receiving data to be stored in memory.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, NAND, 3DXP, or optical based disks, or a combination. Storage 584 holds code or instructions and data 586 in a persistent state (i.e., the value is retained despite interruption of power to system 500). Storage 584 can be generically considered to be a “memory,” although memory module(s) 530 is typically the executing or operating memory to provide instructions to processor 510. Whereas storage 584 is nonvolatile, memory module(s) 530 can include volatile memory (i.e., the value or state of the data is indeterminate if power is interrupted to system 500). In one example, storage subsystem 580 includes controller 582 to interface with storage 584. In one example controller 582 is a physical part of interface 514 or processor 510, or can include circuits or logic in both processor 510 and interface 514.

Power source 502 provides power to the components of system 500. More specifically, power source 502 typically interfaces to one or multiple power supplies 504 in system 500 to provide power to the components of system 500. In one example, power supply 504 includes an AC to DC (alternating current to direct current) adapter to plug into a wall outlet. Such AC power can be renewable energy (e.g., solar power) power source 502. In one example, power source 502 includes a DC power source, such as an external AC to DC converter. In one example, power source 502 or power supply 504 includes wireless charging hardware to charge via proximity to a charging field. In one example, power source 502 can include an internal battery or fuel cell source.

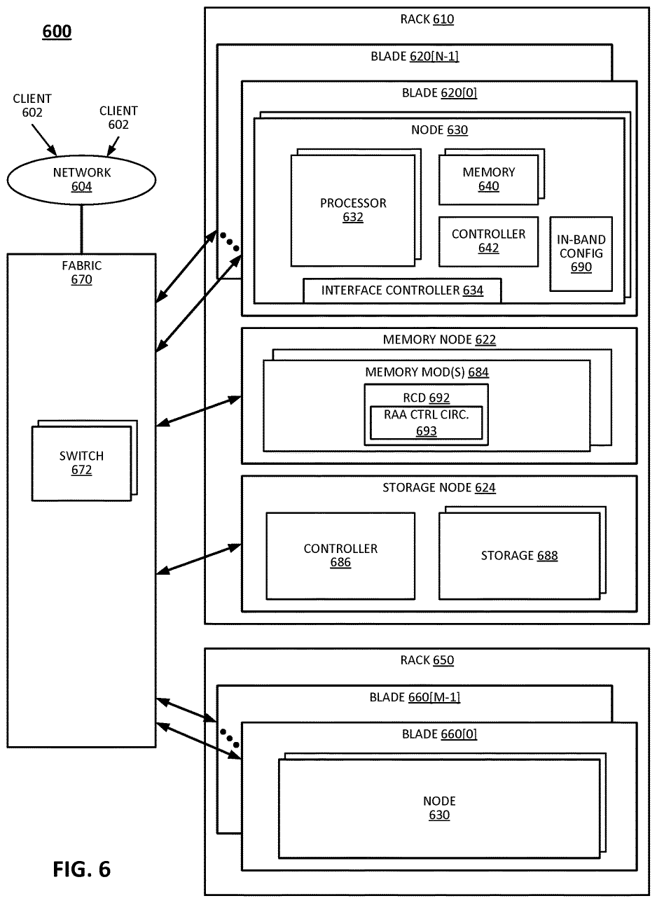

FIG. 6 illustrates an example of a multi-node network in which row hammer or row disturb conditions can be detected and/or mitigated at a memory module of a memory node. System 600 represents a network of nodes that can apply row hammer or row disturb detection and mitigation at a memory node. In one example, system 600 represents a data center. In one example, system 600 represents a server farm. In one example, system 600 represents a data cloud or a processing cloud.

System 600 can represent a system with volatile memory at a memory module in accordance with an example of system 100 described above and shown in FIG. 1. In one example, system 600 includes memory node 622, Memory node 622 can include memory module(s) 684 having at least one RCD 692. RCD 692 can include RAA control circuitry 693. RAA control circuitry 693 can include similar logic and/features as mentioned above and shown in FIG. 2 for RAA control circuitry 123 to maintain an activate count for ACT commands addressed to each row address of volatile memory devices resident on memory module(s) 684. The activate count can be incremented responsive to an ACT received from a memory controller (e.g., controller 642 or a memory controller at processor 632) and based on a comparison of the incremented activate count to a count threshold, a row hammer or a row disturb condition can be detected and/or mitigated as mentioned above and shown in FIG. 3. Also, RAA control circuitry 693 can be configured to generate an alert based on a detected row hammer or row disturb conditions such that a memory controller can issue commands (e.g., DRFM commands) to mitigate the detected row hammer or row disturb conditions.

One or more clients 602 make requests over network 604 to system 600. Network 604 represents one or more local networks, or wide area networks, or a combination. Clients 602 can be human or machine clients, which generate requests for the execution of operations by system 600. System 600 executes applications or data computation tasks requested by clients 602.

In one example, system 600 includes one or more racks, which represent structural and interconnect resources to house and interconnect multiple computation nodes. In one example, rack 610 includes multiple nodes 630. In one example, rack 610 hosts multiple blade components, blade 620[0], . . . , blade 620[N−1], collectively blades 620. Hosting refers to providing power, structural or mechanical support, and interconnection. Blades 620 can refer to computing resources on printed circuit boards (PCBs), where a PCB houses the hardware components for one or more nodes 630. In one example, blades 620 do not include a chassis or housing or other “box” other than that provided by rack 610. In one example, blades 620 include housing with exposed connector to connect into rack 610. In one example, system 600 does not include rack 610, and each blade 620 includes a chassis or housing that can stack or otherwise reside in close proximity to other blades and allow interconnection of nodes 630.

System 600 includes fabric 670, which represents one or more interconnectors for nodes 630. In one example, fabric 670 includes multiple switches 672 or routers or other hardware to route signals among nodes 630. Additionally, fabric 670 can couple system 600 to network 604 for access by clients 602. In addition to routing equipment, fabric 670 can be considered to include the cables or ports or other hardware equipment to couple nodes 630 together. In one example, fabric 670 has one or more associated protocols to manage the routing of signals through system 600. In one example, the protocol or protocols is at least partly dependent on the hardware equipment used in system 600.

As illustrated, rack 610 includes N blades 620. In one example, in addition to rack 610, system 600 includes rack 650. As illustrated, rack 650 includes M blade components, blade 660[0], . . . , blade 660[M−1], collectively blades 660. M is not necessarily the same as N; thus, it will be understood that various different hardware equipment components could be used, and coupled together into system 600 over fabric 670. Blades 660 can be the same or similar to blades 620. Nodes 630 can be any type of node and are not necessarily all the same type of node. System 600 is not limited to being homogenous, nor is it limited to not being homogenous.

The nodes in system 600 can include compute nodes, memory nodes, storage nodes, accelerator nodes, or other nodes. Rack 610 is represented with memory node 622 and storage node 624, which represent shared system memory resources, and shared persistent storage, respectively. One or more nodes of rack 650 can be a memory node or a storage node.

Nodes 630 represent examples of compute nodes. For simplicity, only the compute node in blade 620[0] is illustrated in detail. However, other nodes in system 600 can be the same or similar. At least some nodes 630 are computation nodes, with processor (proc) 632 and memory 640. A computation node refers to a node with processing resources (e.g., one or more processors) that executes an operating system and can receive and process one or more tasks. In one example, at least some nodes 630 are server nodes with a server as processing resources represented by processor 632 and memory 640.

Memory node 622 represents an example of a memory node, with system memory external to the compute nodes. Memory nodes can include controller 682, which represents a processor on the node to manage access to the memory. The memory nodes include memory 684 as memory resources to be shared among multiple compute nodes.

Storage node 624 represents an example of a storage server, which refers to a node with more storage resources than a computation node, and rather than having processors for the execution of tasks, a storage server includes processing resources to manage access to the storage nodes within the storage server. Storage nodes can include controller 686 to manage access to the storage 688 of the storage node.

In one example, node 630 includes interface controller 634, which represents logic to control access by node 630 to fabric 670. The logic can include hardware resources to interconnect to the physical interconnection hardware. The logic can include software or firmware logic to manage the interconnection. In one example, interface controller 634 is or includes a host fabric interface, which can be a fabric interface in accordance with any example described herein. The interface controllers for memory node 622 and storage node 624 are not explicitly shown.

Processor 632 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 640 can be or include memory devices represented by memory 640 and a memory controller represented by controller 642.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” and may be similar to IP blocks. IP cores may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

The follow examples pertain to additional examples of technologies disclosed herein.
Example 1. An example apparatus on a memory module can include a CA interface to couple with a CA bus that is coupled to a memory controller. The apparatus can also include circuitry. The circuitry can be configured to receive, via the CA interface, an ACT command sent over the CA bus from the memory controller, the ACT command to indicate a row address to activate at a volatile memory device on the memory module. The circuitry can also be configured to increment an activate count for the row address to generate an updated activate count. The circuitry can also be configured to compare the updated activate count to a threshold count. The circuitry can also be configured to cause an alert message to be sent to the memory controller if the updated activate count matches the threshold count.
Example 2. The apparatus of example 1, the circuitry can also be configured to block the command from being forwarded to the volatile memory device if the updated activate count matches the threshold count.
Example 3. The apparatus of example 1, the circuitry can also be configured to reset the activate count for the row address if the updated activate count matches the threshold count.
Example 4. The apparatus of example 1, the memory module can be a DIMM and the volatile memory device can be a DRAM device.
Example 5. The apparatus of example 1, the apparatus can be a RCD resident on the DIMM.
Example 6. The apparatus of example 1, the alert message sent to the memory controller can cause the memory controller to issue a DRFM command to the volatile memory device. The DRFM command can cause the volatile memory device to refresh row addresses at the volatile memory device that are adjacent to the row address indicated in the ACT command.
Example 7. The apparatus of example 1, to cause the alert message to be sent to the memory controller if the updated activate count matches the threshold count can also include the circuitry to issue a DRFM command to the volatile memory device. The DRFM command can cause the volatile memory device to refresh row addresses at the volatile memory device that are adjacent to the row address indicated in the ACT command.
Example 8. The apparatus of example 7, the alert message sent to the memory controller can indicate that the DRFM command has been issued to the volatile memory device.
Example 9. An example method can include receiving, at controller circuitry on a memory module, an ACT command sent over a command and address bus from a memory controller. The ACT command can indicate a row address to activate at a volatile memory device on the memory module. The method can also include incrementing an activate count for the row address to generate an updated activate count. The method can also include comparing the updated activate count to a threshold count. The method can also include causing an alert message to be sent to the memory controller if the updated activate count matches the threshold count.
Example 10. The method of example 9 can also include blocking the command from being forwarded to the volatile memory device if the updated activate count matches the threshold count.
Example 11. The method of example 9 can also include resetting the activate count for the row address if the updated activate count matches the threshold count.
Example 12. The method of example 9, the memory module can be a DIMM and the volatile memory device can be a DRAM device.
Example 13. The method of example 12, the controller circuitry can be included in a RCD resident on the DIMM.
Example 14. The method of example 9, the alert message sent to the memory controller can cause the memory controller to send a DRFM command to the volatile memory device. The DRFM command can cause the volatile memory device to refresh row addresses at the volatile memory device that are adjacent to the row address indicated in the ACT command.
Example 15. The method of example 9, causing the alert message to be sent to the memory controller if the updated activate count matches the threshold count can also include issuing a DRFM command to the volatile memory device. The DRFM command can cause the volatile memory device to refresh row addresses at the volatile memory device that are adjacent to the row address indicated in the ACT command.
Example 16. The method of example 15, the alert message sent to the memory controller can indicate that the DRFM command has been issued to the volatile memory device.
Example 17. An example at least one machine readable medium can include a plurality of instructions that in response to being executed by a system can cause the system to carry out a method according to any one of examples 9 to 16.
Example 18. An example apparatus can include means for performing the methods of any one of examples 9 to 16.
Example 19. An example memory module can include a plurality of volatile memory devices and a controller that includes a CA interface to couple with a CA bus that is coupled to a memory controller and includes circuitry. The circuitry can be configured to receive, via the CA interface, an ACT command sent over the CA bus from the memory controller. The ACT command can indicate a row address to activate at a volatile memory device from among the plurality of volatile memory devices. The circuitry can also be configured to increment an activate count for the row address to generate an updated activate count. The circuitry can also be configured to compare the updated activate count to a threshold count. The circuitry can also be configured to cause an alert message to be sent to the memory controller if the updated activate count matches the threshold count.
Example 20. The memory module of example 19, the circuitry can also be configured to block the command from being forwarded to the volatile memory device if the updated activate count matches the threshold count.
Example 21. The memory module of example 19, the circuitry can also be configured reset the activate count for the row address if the updated activate count matches the threshold count.
Example 22. The memory module of example 19, the memory module can be a DIMM and the plurality of volatile memory devices can be DRAM devices.
Example 23. The memory module of example 22, the controller can be an RCD.
Example 24. The memory module of example 19, the alert message sent to the memory controller can cause the memory controller to issue a DRFM command to the volatile memory device. The DRFM command can cause the volatile memory device to refresh row addresses at the volatile memory devices that are adjacent to the row address indicated in the ACT command.
Example 25. The memory module of example 19, to cause the alert message to be sent to the memory controller if the updated activate count matches the threshold count can also include the circuitry to issue a DRFM command to the volatile memory device. The DRFM command can cause the volatile memory device to refresh row addresses at the volatile memory devices that are adjacent to the row address indicated in the ACT command.
Example 26. The memory module of example 25, the alert message sent to the memory controller can indicate that the DRFM command has been issued to the volatile memory device.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system comprising:
processing circuitry coupled to controller circuitry, the controller circuitry to:
receive an activate (ACT) command sent over a command and address bus from a memory controller, the ACT command to indicate a row address to activate at a volatile memory device on a memory module, wherein the controller circuitry is associated with the memory module having a dual in-line memory module (DIMM);
increment a per row activate counter that represents an activate count for the row address to generate an updated activate count;
compare the updated activate count to a threshold count; and
cause an alert message to be sent to the memory controller if the updated activate count matches the threshold count.

2. The computing system of claim 1, wherein the controller circuitry is further to:
issue a directed refresh management (DRFM) command to the volatile memory device, the DRFM command to cause the volatile memory device to refresh row addresses at the volatile memory device that are adjacent to the row address indicated in the ACT command.

3. The computing system of claim 1, wherein the controller circuitry is further to:
block the ACT command from being forwarded to the volatile memory device if the updated activate count matches the threshold count.

4. The computing system of claim 1, wherein the controller circuitry is further to:
reset the activate count for the row address if the updated activate count matches or exceeds the threshold count.

5. The computing system of claim 1, wherein the volatile memory device comprises a dynamic random access memory (DRAM) device.

6. The computing system of claim 1, wherein the DIMM to have a registered clock driver (RCD) residing on the DIMM.

7. The computing system of claim 1, wherein the processing circuitry comprises application processing circuitry.

8. A computing device comprising:
processing circuitry coupled to controller circuitry, the controller circuitry to:
receive an activate (ACT) command sent over a command and address bus from a memory controller, the ACT command to indicate a row address to activate at a volatile memory device on a memory module, wherein the controller circuitry is associated with the memory module having a dual in-line memory module (DIMM);
increment a per row activate counter that represents an activate count for the row address to generate an updated activate count;
compare the updated activate count to a threshold count; and
cause an alert message to be sent to the memory controller if the updated activate count matches the threshold count.

9. The computing device of claim 8, wherein the controller circuitry is further to:
issue a directed refresh management (DRFM) command to the volatile memory device, the DRFM command to cause the volatile memory device to refresh row addresses at the volatile memory device that are adjacent to the row address indicated in the ACT command.

10. The computing device of claim 8, wherein the controller circuitry is further to:
block the ACT command from being forwarded to the volatile memory device if the updated activate count matches the threshold count.

11. The computing device of claim 8, wherein the controller circuitry is further to:
reset the activate count for the row address if the updated activate count matches or exceeds the threshold count.

12. The computing device of claim 8, wherein the volatile memory device comprises a dynamic random access memory (DRAM) device.

13. The computing device of claim 8, wherein the DIMM to have a registered clock driver (RCD) residing on the DIMM.

14. The computing device of claim 8, wherein the processing circuitry comprises application processing circuitry.

15. At least one computer-readable medium having stored thereon instructions which, when executed, cause a computing device to perform operations comprising:
receiving, via controller circuitry coupled to processing circuitry of the computing device, an activate (ACT) command sent over a command and address bus from a memory controller, the ACT command to indicate a row address to activate at a volatile memory device on a memory module, wherein the controller circuitry is associated with the memory module having a dual in-line memory module (DIMM);
incrementing a per row activate counter that represents an activate count for the row address to generate an updated activate count;
comparing the updated activate count to a threshold count; and
causing an alert message to be sent to the memory controller if the updated activate count matches the threshold count.

16. The computer-readable medium of claim 15, wherein the operations further comprise:
issuing a directed refresh management (DRFM) command to the volatile memory device, the DRFM command to cause the volatile memory device to refresh row addresses at the volatile memory device that are adjacent to the row address indicated in the ACT command.

17. The computer-readable medium of claim 15, wherein the operations further comprise:
block the ACT command from being forwarded to the volatile memory device if the updated activate count matches the threshold count.

18. The computer-readable medium of claim 15, wherein the operations further comprise:
reset the activate count for the row address if the updated activate count matches or exceeds the threshold count.

19. The computer-readable medium of claim 15, wherein the volatile memory device comprises a dynamic random access memory (DRAM) device.

20. The computer-readable medium of claim 15, wherein the DIMM to have a registered clock driver (RCD) residing on the DIMM, wherein the processing circuitry comprises application processing circuitry.
